(19) United States
(12) Patent Application Publication
(10) Pub. No.: US 2024/0077057 A1
(43) Pub. Date: Mar. 7, 2024

(54) A METHOD FOR STARTING A WIND TURBINE WITH HINGED WIND TURBINE BLADES

(71) Applicant: VESTAS WIND SYSTEMS A/S, Aarhus N. (DK)

(72) Inventors: Thomas S. Bjertrup NIELSEN, Randers SV (DK); Peter Bjorn ANDERSEN, Skanderborg (DK); Soren DALSGAARD, Hadsten (DK); Kim Hylling SORENSEN, Aarhus C (DK)

(21) Appl. No.: 17/766,969

(22) PCT Filed: Oct. 8, 2020
(86) PCT No.: PCT/DK2020/050276

§ 371 Date: Apr. 6, 2022

(30) Foreign Application Priority Data
Oct. 8, 2019 (DK) PA 2019 70627

(51) Int. Cl. F03D 7/02; F03D 9/25; H02P 9/08

(52) U.S. Cl. CPC F03D 7/026; F03D 7/0239; F03D 9/255; H02P 9/08; F05B 2220/706; F05B 2240/2022; F05B 2260/85; H02P 2101/15

(57) ABSTRACT

A method for starting a wind turbine with hinged wind turbine blades, the wind turbine further comprising an adjustable biasing mechanism arranged to apply an adjustable biasing force to each wind turbine blade which biases the wind turbine blade towards a position defining a minimum pivot angle. The biasing mechanism is adjusted to apply a predefined biasing force to each wind turbine blade, and the pivot angle of each wind turbine blade is monitored. The wind turbine is started in the case that the pivot angle of at least one wind turbine blade exceeds a predefined pivot angle threshold.

### FIELD OF THE INVENTION

The present invention relates to a method for starting a wind turbine with hinged wind turbine blades. The method according to the invention ensures that the wind turbine is reliably started whenever sufficient energy is available in the wind.

### BACKGROUND OF THE INVENTION

Wind turbines are normally controlled in order to provide a desired power output and in order to control loads on the wind turbine. For horizontal axis wind turbines, i.e. wind turbines with a rotor which rotates about a substantially horizontal rotor axis, this may be obtained by controlling a pitch angle of the wind turbine blades. In this case the angle of attack of the wind turbine blades relative to the wind is adjusted by rotating the wind turbine blades about a longitudinal axis.

As an alternative, wind turbines may be provided with wind turbine blades which are connected to a blade carrying structure via hinges, thereby allowing a pivot angle defined between the wind turbine blades and the blade carrying structure to be varied. In such wind turbines the diameter of the rotor of the wind turbine, and thereby the area swept by the rotor, is varied when the pivot angle is varied. Examples of such a wind turbine is disclosed in U.S. Pat. No. 4,632,637 and US 2010/0226772.

When a wind turbine has been stopped, e.g. due to low wind speed, excessively high wind speed, service, repair, or for any other reason, it must be ensured that the energy available in the wind is within a suitable range before the wind turbine is once again started. In order to determine whether or not this is the case, the wind speed may be measured, e.g. using a suitable wind speed detector, such as an anemometer. The wind speed detector may be mounted on the wind turbine, e.g. on top of a nacelle, or it may be arranged in the vicinity of the wind turbine. However, such wind speed measurements may be unprecise, since they may only provide the wind speed at a position near the wind turbine, not at the precise position of the wind turbine, and since measurements made by a wind speed detector mounted on the nacelle of the wind turbine may be disturbed by the operation of the wind turbine. Furthermore, wind speed variations may occur across the rotor plane, and a wind speed measurement performed in a single point may therefore not take such variations into account, and may therefore not form a representative basis for determining whether or not the prevailing wind conditions are suitable for starting the wind turbine. Finally, even though the energy available in the wind depends on the wind speed, other factors, such as air density, humidity, etc., also affect the energy available in the wind, and the wind speed is therefore not an accurate measure for the available energy.

### DESCRIPTION OF THE INVENTION

It is an object of embodiments of the invention to provide a method for starting a wind turbine with hinged wind turbine blades, in which it is reliably ensured that the wind turbine is started up whenever the energy available in the wind is within a suitable range.

The invention provides a method for starting a production of electrical energy of a wind turbine after a period of not producing electrical energy, the wind turbine comprising a tower, a nacelle mounted on the tower via a yaw system, a hub mounted rotatably on the nacelle, the hub comprising a blade carrying structure, and one or more wind turbine blades connected to the blade carrying structure via a hinge, each wind turbine blade thereby being arranged to perform pivot movements relative to the blade carrying structure between a minimum pivot angle and a maximum pivot angle, the wind turbine further comprising an adjustable biasing mechanism arranged to apply an adjustable biasing force to each wind turbine blade which biases the wind turbine blade towards a position defining a minimum pivot angle, the method comprising the steps of:
adjusting the biasing mechanism to apply a predefined biasing force to each wind turbine blade,
monitoring the pivot angle of each wind turbine blade, and
starting the wind turbine in the case that the pivot angle of at least one wind turbine blade exceeds a predefined pivot angle threshold.

Thus, the method of the invention is a method for starting a wind turbine. In the present context the term ‘wind turbine’ should be interpreted to mean a construction which is capable of extracting energy from the wind and transforming it into electrical energy.

In the present context the term ‘starting a wind turbine’ should be interpreted to mean starting a production of electrical energy of a wind turbine following a period of not producing electrical energy.

The wind turbine comprises a tower, a nacelle, a hub and one or more wind turbine blades. The nacelle is mounted on the tower via a yaw system, thereby allowing the nacelle to be rotated relative to the tower in order to direct the wind turbine blade in accordance with the direction of the incoming wind. The yaw system may be an active yaw system in which the nacelle is rotated actively by means of a yaw drive mechanism, e.g. on the basis of measurements of the wind direction. As an alternative, the yaw system may be a passive yaw system in which the nacelle automatically rotates according to the wind direction without the use of a yaw drive mechanism. As another alternative, the yaw system may be a combination of an active yaw system and a passive yaw system, in the sense that it may operate actively under some circumstances and passively under other circumstances.

The hub comprises a blade carrying structure, and the wind turbine blades are connected to the blade carrying structure via a hinge. Thereby each of the wind turbine blades is arranged to perform pivot movements relative to the blade carrying structure, via the hinge. A pivot angle is thereby defined between each wind turbine blade and the blade carrying structure, depending on the position of the hinge and thereby of the wind turbine blade relative to the blade carrying structure. Accordingly, the pivot angle defines the direction along which a given wind turbine blade extends relative to the blade carrying structure, and thereby relative to the hub. This, in turn, determines a diameter of the rotor, and thereby the ability of the wind turbine to extract energy from the wind.

The pivot angle can vary between a minimum pivot angle, e.g. defining a maximum rotor diameter, and a maximum pivot angle, e.g. defining a minimum rotor diameter. Positioning the wind turbine blades at maximum pivot angle, and thereby minimum rotor diameter, is sometimes referred to as ‘barrel mode’.

Thus, the wind turbine is of a kind which comprises hinged wind turbine blades. The hinge may be or comprise a bearing, e.g. in the form of a journal bearing, a roller bearing, or any other suitable kind of bearing.

The hub is mounted rotatably on the nacelle. Since the wind turbine blades are mounted on the hub, they rotate along with the hub, relative to the nacelle.

The wind turbine further comprises an adjustable biasing mechanism arranged to apply an adjustable biasing force to each wind turbine blade. The biasing force biases the wind turbine blades towards a position defining a minimum pivot angle, and thereby maximum rotor diameter. Thereby, pivot movements of the wind turbine blades towards larger pivot angles are performed against the biasing force. Furthermore, if no other forces act on the wind turbine blades, the biasing force will cause the wind turbine blades to be positioned at the minimum pivot angle.

Since the biasing force is adjustable, it is possible to adjust how large an oppositely directed force is required in order to move the wind turbine blades away from the minimum pivot angle.

The biasing force could, e.g., be applied by means of wires attached to inner blade parts of the wind turbine blades, which pull the wind turbine blades outwards, i.e. towards the minimum pivot angle. In this case the biasing force can be adjusted by adjusting the pulling force applied by the wires.

As an alternative, the biasing force could be applied by means of one or more springs acting on the wind turbine blades, e.g. compressible springs arranged for pulling or pushing the wind turbine blades towards the minimum pivot angle. In this case the biasing force can, e.g., be adjusted by means of pulleys or hydraulic actuators mounted in the hub, in the blade carrying structure, in the wind turbine blade itself, in the nacelle or in the tower.

As another alternative, the biasing force could be in the form of a moment. In this case the biasing force could be applied by means of a torsional spring arranged in the hinge which pulls or pushes the wind turbine blades towards the minimum pivot angle. In this case the biasing force may also be adjusted by varying the torsional moment, e.g. by means of pulleys or hydraulic actuators mounted in the hub, in the blade carrying structure, in the wind turbine blade itself, in the nacelle or in the tower.

As another alternative, the biasing force could be applied by means of hydraulic mechanisms connected to the wind turbine blades and being arranged for pulling or pushing the wind turbine blades towards the minimum pivot angle. In this case the biasing force can be adjusted by adjusting the pressure in the hydraulic mechanisms.

In the method according to the invention, the biasing mechanism is initially adjusted to apply a predefined biasing force to each wind turbine blade, while the wind turbine is stopped or idling. Thus, the wind turbine blades are initially pulled or pushed towards the minimum pivot angle with a specified, predefined force.

Next, the pivot angle of each wind turbine blade is monitored. Wind acting on the wind turbine blades will attempt to push the wind turbine blades towards larger pivot angles, i.e. the force applied by the wind will act against the biasing force. Thus, when the force applied by the wind exceeds the predefined biasing force, the wind turbine blades will start moving towards larger pivot angles. The larger the force applied by the wind, the larger the pivot angle will be. The force applied by the wind is a direct measure for the available energy in the wind.

Furthermore, at some point the wind acting on the aerodynamic profiles of the wind turbine blades may cause the hub to rotate, and the rotational speed depends on the available energy in the wind.

It should be noted that the step of monitoring the rotational speed of the hub may be performed by directly monitoring the rotational movements of the hub and/or it may be performed by monitoring the rotational movements of a generator connected to the hub, since the rotational speed of the hub and the rotational speed of the generator are proportional to each other by a proportionality factor which is determined by a gearing ratio of a gear interconnecting the hub and the generator. In the case of a direct drive wind turbine the rotational speeds are identical.

In any event, when the available energy in the wind exceeds a certain threshold, the pivot angles of the wind turbine blades will exceed a certain pivot angle threshold. Thereby, by monitoring the pivot angles, it can easily and directly be determined whether or not the available energy in the wind is sufficient to operate the wind turbine. This provides a significantly more precise and reliable basis for determining whether or not the wind turbine can suitably be started, than a point measurement of the wind speed.

Accordingly, the wind turbine is started in the case that the pivot angle of at least one wind turbine blade exceeds a predefined pivot angle threshold.

Thereby it is ensured that the wind turbine is started whenever sufficient energy is available in the wind, and it is ensured that the wind turbine is not started when the available energy in the wind is insufficient to provide appropriate operation of the wind turbine.

In an embodiment, a further step of monitoring the rotational speed of the hub may be done, where the wind turbine is started in the case that the rotational speed of the hub exceeds a predefined rotational speed threshold.

When the available energy in the wind exceeds a certain threshold, the rotational speed of the hub may exceed a certain rotational speed threshold.

Thereby, by further monitoring the rotational speed of the hub, it can also be determined whether or not the available energy in the wind is sufficient to operate the wind turbine.

In the case that the wind turbine was stopped or idling due to low wind, then the biasing force will initially cause the wind turbine blades to be at a pivot angle which is at or near the minimum pivot angle, and the rotational speed of the hub will be very low, or the hub may even be non-rotating. When the wind speed starts increasing, the pivot angle will start increasing, as described above. Furthermore, the hub may start rotating or the rotational speed may increase. As soon as the pivot angle of at least one wind turbine blades exceeds the predefined pivot angle threshold and/or the rotational speed exceeds the predefined rotational speed threshold, thereby indicating that the available energy in the wind is sufficient to ensure appropriate operation of the wind turbine, the wind turbine is started.

In the case that the wind turbine was stopped or idling for other reasons than due to low wind, e.g. due to service, maintenance, faults, etc., the wind speed, and thereby the available energy in the wind, need not be low when the method according to the invention is initiated. In this case the step of monitoring the pivot angles and/or the rotational speed of the hub will immediately reveal that the available energy in the wind is sufficient to ensure appropriate operation of the wind turbine, and the wind turbine will therefore be started up straight away.

The step of starting the wind turbine may comprise initially operating a generator of the wind turbine in motor mode. In the present context the term ‘motor mode’ should be interpreted to mean an operating condition where the generator is reversed to provide power to the wind turbine, thereby converting electrical energy to rotational energy of the hub.

In some cases the aerodynamic properties of the wind turbine blades are such that sufficient lift and drag to operate the wind turbine is only created when the wind turbine blades are moving. Thereby it will be necessary to rotate the hub by operating the generator in motor mode in order to bring the wind turbine blades into a state where the aerodynamic forces acting on the wind turbine blades are able to drive the wind turbine.

The predefined biasing force may be selected to provide a predefined pivot angle at a predefined thrust force. According to this embodiment, the biasing force is selected in such a manner that when a specified oppositely directed thrust force acts on the wind turbine blades, the wind turbine blades will be positioned at the predefined pivot angle. The thrust force could originate from various sources, but may advantageously be due to the wind pushing the wind turbine blades in a direction opposite to the biasing force.

The predefined thrust force could, e.g., be selected in such a manner that is corresponds to a force expected from the wind when the available energy in the wind is sufficient to ensure appropriate operation of the wind turbine. In this case the wind turbine will be started when the pivot angle exceeds the predefined pivot angle.

The method may further comprise the step of allowing a predefined time period to lapse between the step of adjusting the biasing mechanism and the step of monitoring the pivot angle and/or the rotational speed of the hub. According to this embodiment, the wind turbine blades are allowed to settle at an equilibrium pivot angle, in which the biasing force and any other forces acting on the wind turbine blades are balanced, before the monitoring of the pivot angles of the wind turbine blades and/or the rotational speed of the hub is initiated, in order to determine whether or not sufficient energy is available in the wind. Thereby it is ensured that the determination regarding whether or not to start the wind turbine is accurately based.

The method may further comprising the step of, in the case that the pivot angle of at least one wind turbine blade exceeds the pivot angle threshold, adjusting the biasing force in order to maintain the wind turbine blades at the pivot angle of the wind turbine blades at the pivot angle threshold during start of the wind turbine.

According to this embodiment, once it is detected that the pivot angle of at least one of the wind turbine blades exceeds the pivot angle threshold, and the wind turbine is therefore started up, a control of the biasing force is initiated. More particularly, according to this embodiment, the biasing force is adjusted, in accordance with the force applied to the wind turbine blades by the wind, in such a manner that a substantially constant pivot angle is obtained, the pivot angle being identical to the pivot angle threshold. Thereby the biasing force may be controlled in such a manner that it is ensured that the rotational speed of the generator is not increased and that the pivot movement of the wind turbine blades is not faster than the rotational speed of the hub is allowed to follow, thereby avoiding stall. For instance, the biasing force may be controlled based on rotor speed in the sense that rotor speed is ramped up to a higher rotor speed threshold and the pivot angle follows. The generator may be ramping up the rotor speed based on motor mode or the generator may cut-in when the rotor speed is close to constant at the rotor speed threshold.

As an alternative, the biasing force may be adjusted in order to maintain the pivot angle of wind turbine blades at a constant pivot angle, which differs from the pivot angle threshold during start-up of the wind turbine. Such a pivot angle may be referred to as a start-up setpoint.

This embodiment is particularly suitable at high wind speeds, for instance when the wind turbine was stopped due to maintenance or the like, where the pivot angle may initially be well above the pivot angle threshold.

As an alternative, the method may further comprise the step of, in the case that the pivot angle of at least one wind turbine blade exceeds the pivot angle threshold, adjusting the biasing force in order to move the wind turbine blades towards the position defining the minimum pivot angle.

Similarly to the embodiment described above, the biasing force is also adjusted in this case, once it has been determined that sufficient energy is available in the wind. However, according to this embodiment, the biasing force is adjusted in such a manner that the wind turbine blades are moved towards the position defining the minimum pivot angle, i.e. the biasing force is increased. Thereby the wind turbine blades are gradually pivoted from an ‘idling’ position to an ‘operating’ position, in order to obtain a correct combination of biasing force, pivot angle and rotor speed, but without risking stall.

This embodiment is particularly suitable at low wind speeds, for instance when the wind turbine was stopped due to very low wind, where it is desirable to extract as much energy as possible from the wind, and a small pivot angle is therefore required.

The step of starting the wind turbine may be performed in the case that the pivot angle of each of the wind turbine blades exceeds the predefined pivot angle threshold. According to this embodiment, it is not sufficient that the pivot angle of one of the wind turbine blades exceeds the predefined pivot angle threshold in order to determine that sufficient energy is available in the wind, and that the wind turbine should therefore be started. Instead, according to this embodiment, this needs to be the case for all of the wind turbine blades.

The method may further comprise the step of detecting an azimuth position of each of the wind turbine blades, and the step of starting the wind turbine may be performed in the case that the pivot angle of at least one wind turbine blade exceeds a variable pivot angle threshold being dependent on the azimuth position.

The force acting on the wind turbine blades, originating from gravity, depends on the azimuth position of the wind turbine blades. In the present context the term ‘azimuth position’ should be interpreted to mean the position of a wind turbine blade along the rotating direction of the hub.

For instance, in the case that the centre of mass of the wind turbine blade is positioned in an outer portion of the wind turbine blade, i.e. between the hinge and an outer tip of the wind turbine blade, the gravity force will tend to move a wind turbine blade at an azimuth position pointing the wind turbine blade directly upwards towards larger pivot angles, i.e. towards barrel mode. However, the gravity force will tend to move a wind turbine blade at an azimuth position pointing the wind turbine blade directly downwards towards smaller pivot angles.

Similarly, in the case that the centre of mass of the wind turbine blade is positioned in an inner portion of the wind turbine blade, i.e. between the hinge and an inner tip of the wind turbine blade, the gravity force will tend to move a wind turbine blade at an azimuth position pointing the wind turbine blade directly upwards towards smaller pivot angles. And the gravity force will tend to move a wind turbine blade at an azimuth position pointing the wind turbine blade directly downwards towards larger pivot angles, i.e. towards barrel mode.

For wind turbine blades arranged at azimuth positions between the two positions described above, the direction of the force acting on the wind turbine blades, due to gravity, is somewhere in between.

Thus, at a given biasing force and a given opposite thrust force, the pivot angle of a given wind turbine blade depends on its azimuth position. Furthermore, in the case that the wind turbine comprises three wind turbine blades, there will always be at least one of the wind turbine blades which is closer to the azimuth position pointing the wind turbine blade directly upwards than to the azimuth position pointing the wind turbine blade directly downwards, and there will always be at least one of the wind turbine blades which is closer to the azimuth position pointing directly downwards than to the position pointing directly upwards. Thus, at least one of the wind turbine blades can be regarded as a lowermost wind turbine blade, and at least one of the wind turbine blades can be regarded as an uppermost wind turbine blade. Since the gravity force will affect these wind turbine blades differently, as described above, it is appropriate to apply different pivot angle threshold values, depending on the azimuth positions of the wind turbine blades, which take the gravity force on the wind turbine blades into account.

For instance, the method may further comprise the step of detecting an azimuth position of each of the wind turbine blades, and the step of starting the wind turbine may be performed in the case that the pivot angle of at least a lowermost wind turbine blade exceeds a first predefined pivot angle threshold and/or in the case that the pivot angle of at least an upper-most wind turbine blade exceeds a second predefined pivot angle threshold.

The step of starting the wind turbine may comprise the steps of:
connecting a generator to a rotating shaft of the wind turbine,
ramping up the generator, while controlling the biasing force applied by the biasing mechanism to the wind turbine blades, and
connecting the wind turbine to a power grid.

According to this embodiment, the process of starting up the wind turbine includes connecting the generator to a rotating shaft of the wind turbine, the rotating shaft being connected to the hub, possibly via a gear arrangement, and subsequently ramping up the generator, e.g. by providing a torque on the generator. While the generator is ramped up, the biasing force applied by the biasing mechanism to the wind turbine blades is appropriately controlled, e.g. in a manner which adjust the rotational speed of the generator within an overspeed limit.

When the generator has been appropriately ramped up, i.e. when sufficient rotational speed of the generator has been obtained, the wind turbine is connected to a power grid, in the sense that the power flow is changed from power being consumed for accelerating the rotor of the generator to power being supplied to the grid from the wind turbine.

The method may further comprise the step of adjusting the biasing force in order to obtain a rotational acceleration of the generator which is substantially zero prior to connecting the generator to the rotating shaft of the wind turbine. According to this embodiment, smooth connecting of the generator to the rotating shaft of the wind turbine is obtained, by ensuring that the generator speed is close to a reference speed, and that the acceleration of the generators is low.

The step of ramping up the generator may comprise controlling the biasing force as a function of rotational speed of the hub and/or the generator, power output of the generator and pivot angle.

For instance, in situations with low or no generator speed, the biasing force may be kept at a low level, and may be reduced if required, thereby reducing the risk of stall.

In situations with rapidly increasing generator speed, the biasing force may be reduced.

When the generator speed becomes stable, while the generator is operated in motor mode, the biasing force may be increased in order to start extracting power from the wind turbine.

When performing the ramping up of the generator along the lines described above, it is avoided that a too large rotor area is obtained at very low rotor speed. This is desirable because such a situation may lead to stalling of the wind turbine blades, thereby increasing the risk of overspeed once the rotor speed starts increasing. Furthermore, it is ensured that, once the rotational speed of the rotor of the generator is appropriate, the wind turbine blades are slowly moved towards smaller pivot angles, thereby allowing a switch from motor mode to generator mode.

The method may further comprise the step of aligning the nacelle of the wind turbine in accordance with the direction of the wind, by means of the yaw system, prior to the step of adjusting the biasing mechanism.

According to this embodiment, it is ensured that the rotor of the wind turbine is correctly positioned relative to the direction of the incoming wind before the process of determining whether or not sufficient energy is available in the wind is initiated. Thereby the risk of uneven loads on the wind turbine due to yaw misalignment is minimised. In the case that the yaw system is of an active kind, this step may be performed by actively operating the yaw drive mechanism, based on measurements of the wind direction. In the case that the yaw system is of a passive kind, the alignment of the nacelle will be performed automatically.

The wind turbine may advantageously be a downwind wind turbine, i.e. the wind turbine may be of a kind in which the incoming wind passes the nacelle and the tower before reaching the rotor.

### BRIEF DESCRIPTION OF THE DRAWINGS

The invention will now be described in further detail with reference to the accompanying drawings in which

FIGS. 1-3 illustrate a wind turbine being controlled in accordance with a method according to a first embodiment of the invention,

FIGS. 4-6 illustrate a wind turbine being controlled in accordance with a method according to a second embodiment of the invention,

FIGS. 7 and 8 show details of a biasing mechanism for use in a method according to an embodiment of the invention, and

FIG. 9 is a flow chart illustrating a method according to an embodiment of the invention.

### DETAILED DESCRIPTION OF THE DRAWINGS

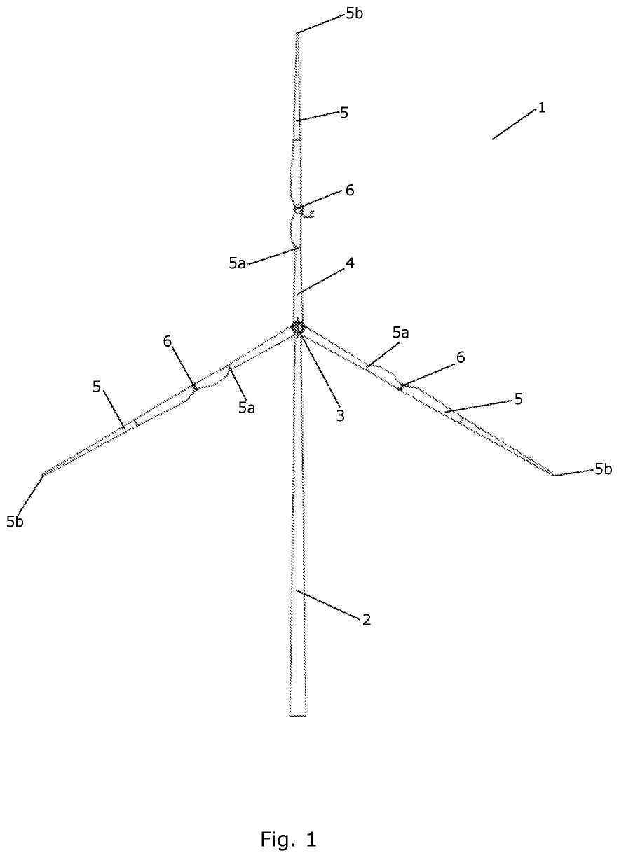

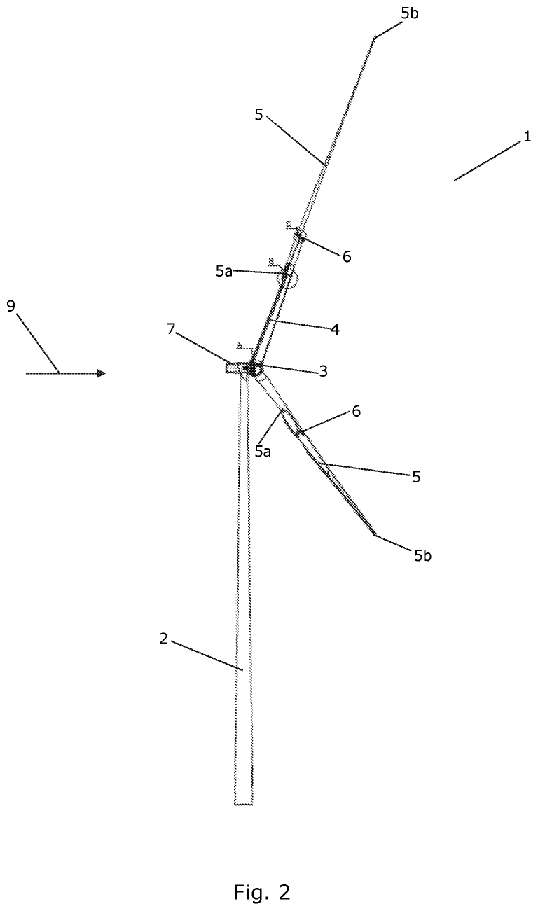

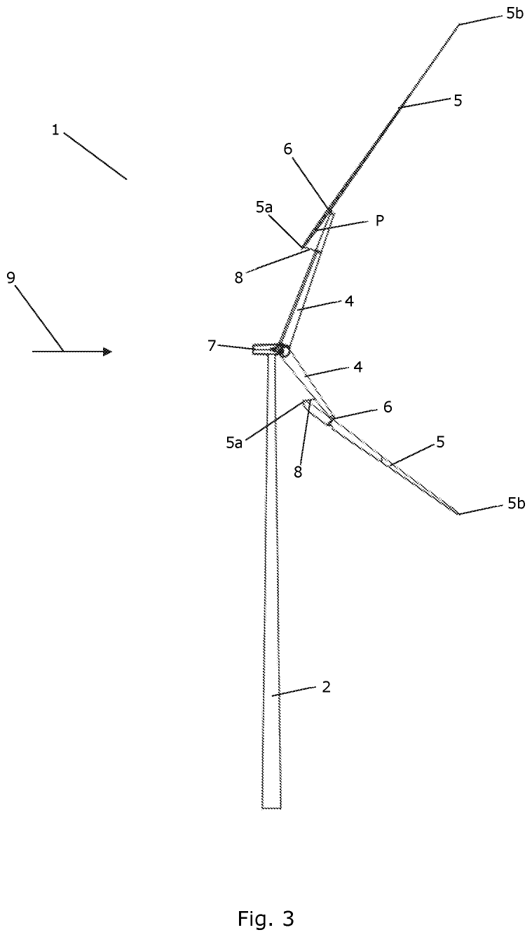

FIGS. 1-3 illustrate a wind turbine 1 being controlled in accordance with a method according to a first embodiment of the invention. FIG. 1 is a front view of the wind turbine 1, and FIGS. 2 and 3 are side views of the wind turbine 1.

The wind turbine 1 of FIGS. 1-3 comprises a tower 2 and a nacelle 7 mounted on the tower 2. A hub 3 is mounted rotatably on the nacelle 7, the hub 3 comprising a blade carrying structure 4 with three arms. A wind turbine blade 5 is connected to each of the arms of the blade carrying structure 4 via a hinge 6.

Thus, the wind turbine blades 5 rotate along with the hub 3, relative to the nacelle 7, and the wind turbine blades 5 can perform pivoting movements relative to the blade carrying structure 4, via the hinges 6.

Each wind turbine blade 5 defines an aerodynamic profile extending along the length of the wind turbine blade 5 between an inner tip end 5a and an outer tip end 5b. The hinge 6 is arranged at a hinge position of the wind turbine blade 5, the hinge position being at a distance from the inner tip end 5a as well as at a distance from the outer tip end 5b. The wind turbine blades 5 of the wind turbine 1 of FIGS. 1-3 are straight in the sense that an inner portion of the wind turbine blade 5, between the hinge 6 and the inner tip end 5a, and an outer portion of the wind turbine blade 5, between the hinge 6 and the outer tip end 5b, extend along the same direction, i.e. an angle is not formed between the inner and outer portions of the wind turbine blade 5.

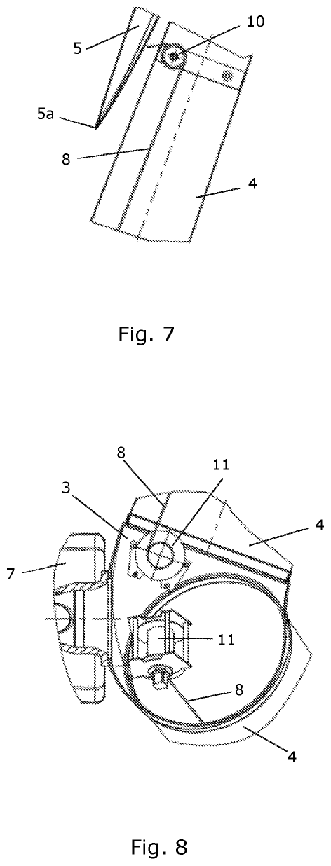

A biasing mechanism comprising wires 8 attached to the wind turbine blades 5 at a position near the inner tip end 5a applies a biasing force to the wind turbine blades 5 which pulls the wind turbine blades 5 towards a position defining minimum pivot angle, and thereby maximum rotor diameter. This will be described in further detail below with reference to FIGS. 7 and 8.

In FIG. 2 the wind turbine blades 5 are positioned at the minimum pivot angle, i.e. at a pivot angle which results in a maximum rotor diameter of the wind turbine 1.

In FIG. 3 the wind turbine blades 5 are positioned at a larger pivot angle P than the minimum pivot angle illustrated in FIG. 2. Thereby the rotor diameter of the wind turbine 1 is smaller in the situation illustrated in FIG. 3 than in the situation illustrated in FIG. 2.

The wind turbine 1 of FIGS. 1-3 is a downwind wind turbine, i.e. the wind direction relative to the wind turbine 1 is illustrated by arrow 9 shown in FIGS. 2 and 3.

The wind turbine 1 of FIGS. 1-3 may be started up in the following manner. Initially the biasing mechanism 8 is adjusted to apply a predefined biasing force to each of the wind turbine blades 5. Thereby the wind turbine blades 5 are pulled towards the position shown in FIG. 2. However, the biasing force is selected in such a manner that when the wind 9 acts on the wind turbine blades 5, the wind turbine blades 5 start pivoting when the energy available in the wind exceeds a certain level.

The pivot angles of the wind turbine blades 5 are then monitored, and when the pivot angle of the wind turbine blades 5 exceeds a predefined pivot angle threshold, e.g. the pivot angle shown in FIG. 3, it can be assumed that the energy available in the wind is sufficient to ensure appropriate operation of the wind turbine 1. Accordingly, when this is detected the wind turbine 1 is started up.

Additionally, a rotational speed of the hub 3 may be monitored, and the wind turbine 1 may be started up when the rotational speed of the hub 3 exceeds a predefined rotational speed threshold, also indicating that the energy available in the wind is sufficient to ensure appropriate operation of the wind turbine 1.

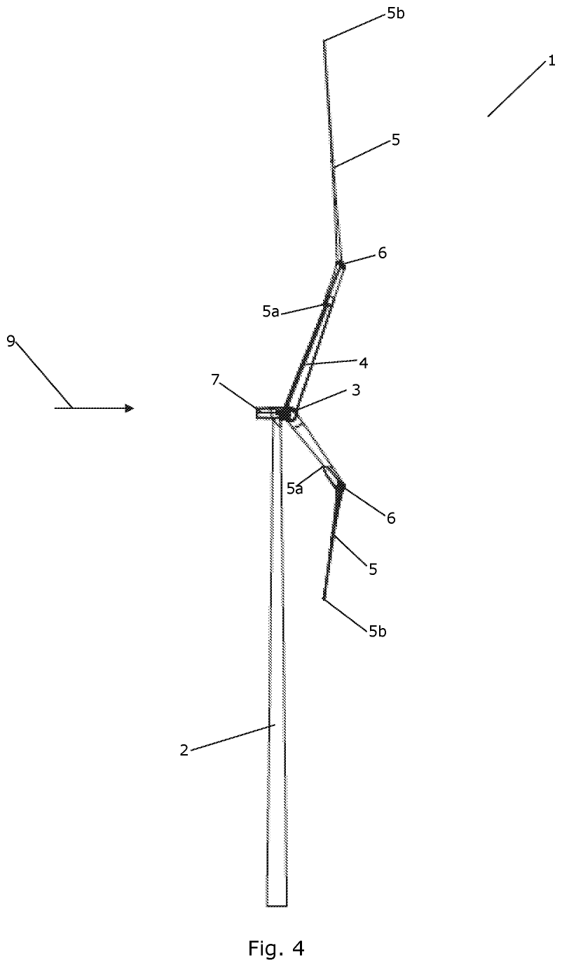

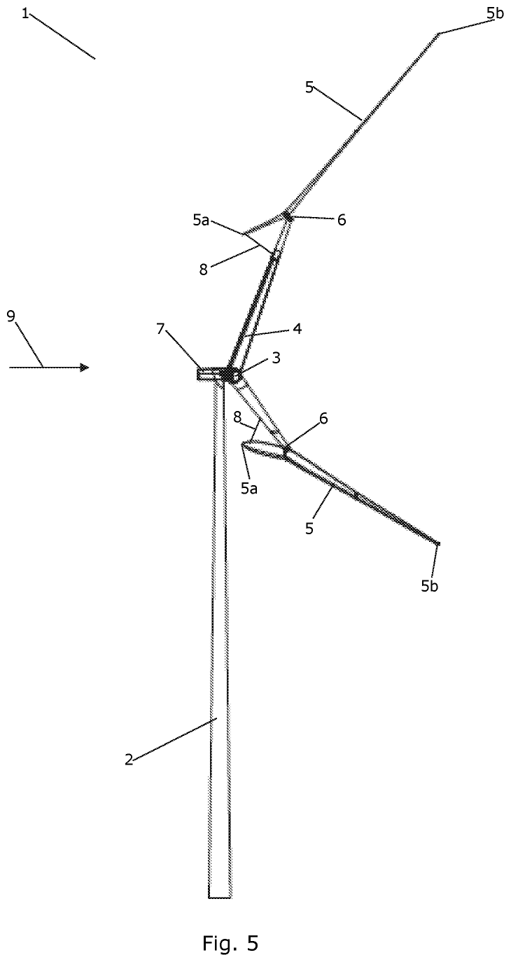

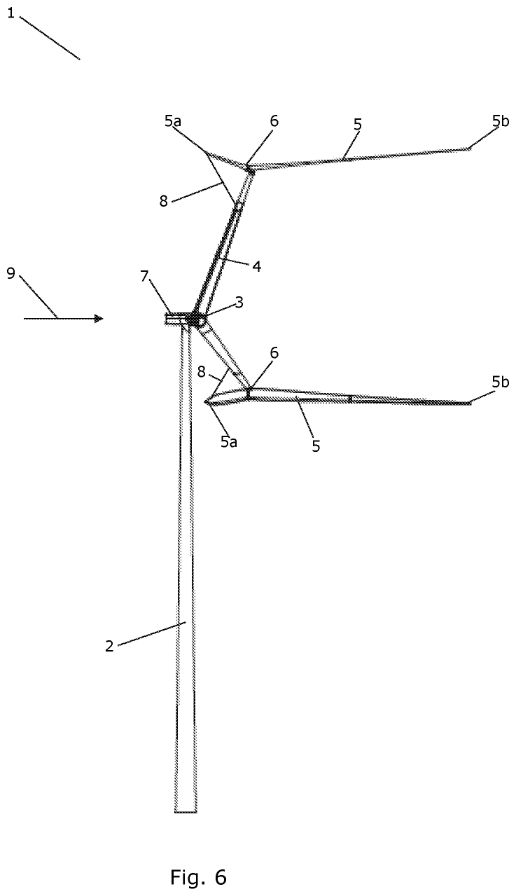

FIGS. 4-6 illustrate a wind turbine 1 being controlled in accordance with a method according to a second embodiment of the invention. The wind turbine 1 of FIGS. 4-6 is very similar and will therefore not be described in detail here. FIGS. 4-6 are all side views of the wind turbine 1 with the wind turbine blades 5 arranged at three different pivot angles. FIG. 4 shows the wind turbine blades 5 at minimum pivot angle, FIG. 6 shows the wind turbine blades 5 at maximum pivot angle, or barrel mode, and FIG. 5 shows the wind turbine blades 5 at an intermediate pivot angle.

The wind turbine blades 5 of the wind turbine 1 of FIGS. 4-6 are angled in the sense that the inner portion and the outer portion of the wind turbine blade 5 extend from the hinge 6 along different directions, forming an angle there between.

FIGS. 7 and 8 show details of a biasing mechanism for applying a biasing force to wind turbine blades 5 of a wind turbine, e.g. the wind turbine 1 of FIGS. 1-3 or the wind turbine 1 of FIGS. 4-6.

FIG. 7 shows a portion of a blade carrying structure 4 and a portion of a wind turbine blade 5. The wind turbine blade 5 is pivotally mounted on the blade carrying structure 4 via a hinge (not shown). A wire 8 is connected to the wind turbine blade 5 at a position between an inner tip end 5a of the wind turbine blade 5 and the position of the hinge. The wire 8 extends from the connecting position at the wind turbine blade 5, via a pulley 10 and along the blade carrying structure 4 towards a hub (not shown).

A biasing force applied by means of the wire 8 pulls the wind turbine blade 5 towards a position defining a minimum pivot angle. In FIG. 7 the wind turbine blade 5 is arranged at the minimum pivot angle. Reducing the biasing force applied by means of the wire 8 will allow the wind turbine blade 5 to more easily pivot towards larger pivot angles.

FIG. 8 is a cross sectional view of part of a hub 3 and part of a nacelle 7. Arms of a blade carrying structure 4 are mounted on the hub 3. The wires 8 which are also illustrated in FIG. 7 are connected to a winch mechanisms 11 arranged in the hub 3. Thereby the biasing force applied by means of the wires 8 can be adjusted by rotating the winch mechanisms 11, thereby adjusting the length of the wires 8.

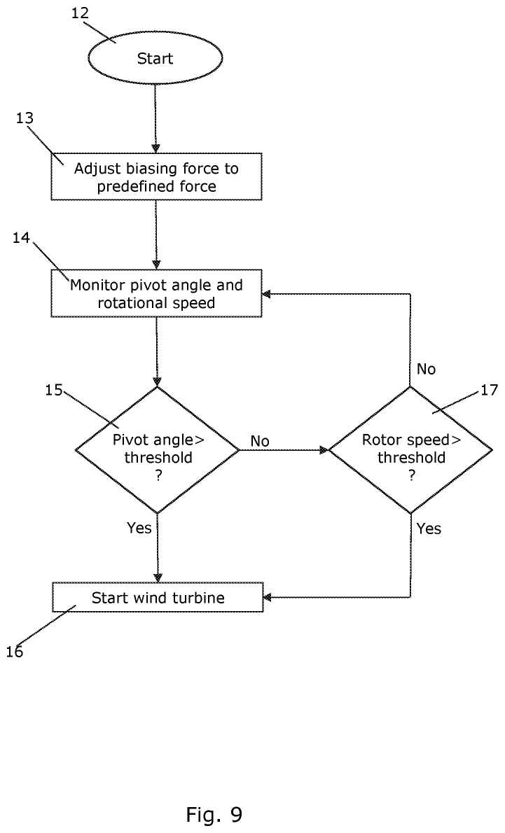

FIG. 9 is a flow chart illustrating a method according to an embodiment of the invention. The process is started at step 12. At step 13 a biasing force applied to the wind turbine blades of a wind turbine is adjusted to a predefined biasing force.

At step 14 the pivot angle of the wind turbine blades and the rotational speed of the hub and/or of the generator of the wind turbine are monitored. Wind acting on the wind turbine blades acts against the biasing force, and will therefore attempt to move the wind turbine blades towards larger pivot angles. Therefore, when the force provided by the wind exceeds the biasing force, the wind turbine blades will start moving towards larger pivot angles. Furthermore, the wind acting on the wind turbine blades may cause the hub to rotate.

Thus, at step 15 the pivot angles of the wind turbine blades are compared to a predefined pivot angle threshold. In the case that this comparison reveals that the pivot angle of at least one of the wind turbine blades exceeds the predefined pivot angle threshold, this is an indication that the energy available in the wind is sufficient to ensure appropriate operation of the wind turbine. Therefore the process is forwarded to step 16, and the wind turbine is started.

In the case that step 15 reveals that none of the pivot angles of the wind turbine blades exceeds the predefined pivot angle threshold, the process is forwarded to step 17, where it is investigated whether or not the rotational speed of the hub and/or of the generator exceeds a predefined rotational speed threshold. If this is the case, this is an indication that the energy available in the wind is sufficient to ensure appropriate operation of the wind turbine, even though the pivot angles of the wind turbine blades were not above the predefined pivot angle threshold. Therefore the process is forwarded to step 16, and the wind turbine is started.

In the case that step 17 reveals that the rotational speed of the hub and/or of the generator does not exceed the predefined rotational speed threshold, it can be assumed that the energy available in the wind is insufficient to ensure appropriate operation of the wind turbine, and the wind turbine should therefore not be started. Accordingly, the process is, in this case, returned to step 14 for continued monitoring of the pivot angles and the rotational speed.

1. A method for starting a production of electrical energy of a wind turbine after a period of not producing electrical energy, the wind turbine comprising a tower, a nacelle mounted on the tower via a yaw system, a hub mounted rotatably on the nacelle, the hub comprising a blade carrying structure, and one or more wind turbine blades connected to the blade carrying structure via a hinge, each wind turbine blade thereby being arranged to perform pivot movements relative to the blade carrying structure between a minimum pivot angle and a maximum pivot angle, the wind turbine further comprising an adjustable biasing mechanism arranged to apply an adjustable biasing force to each wind turbine blade which biases the wind turbine blade towards a position defining a minimum pivot angle, the method comprising:
adjusting the biasing mechanism to apply a predefined biasing force to each wind turbine blade;
monitoring the pivot angle of each wind turbine blade; and
starting the wind turbine in the case that the pivot angle of at least one wind turbine blade exceeds a predefined pivot angle threshold.

2. The method of claim 1, further comprising:
monitoring the rotational speed of the hub; and
starting the wind turbine in the case that the rotational speed of the hub exceeds a predefined rotational speed threshold.

3. The method of claim 1, wherein the starting the wind turbine comprises initially operating a generator of the wind turbine in motor mode.

4. The method of claim 1, wherein the predefined biasing force is selected to provide a predefined pivot angle at a predefined thrust force.

5. The method of claim 1, further comprising allowing a predefined time period to lapse between the step of adjusting the biasing mechanism and the step of monitoring the pivot angle.

6. The method of claim 1, further comprising, in the case that the pivot angle of at least one wind turbine blade exceeds the pivot angle threshold, adjusting the biasing force in order to maintain the wind turbine blades at the pivot angle of the wind turbine blades at the pivot angle threshold during start of the wind turbine.

7. The method of claim 1, further comprising, in the case that the pivot angle of at least one wind turbine blade exceeds the pivot angle threshold, adjusting the biasing force in order to move the wind turbine blades towards the position defining the minimum pivot angle.

8. The method of claim 1, wherein the starting the wind turbine is performed in the case that the pivot angle of each of the wind turbine blades exceeds the predefined pivot angle threshold.

9. The method of claim 1, further comprising detecting an azimuth position of each of the wind turbine blades, and wherein the starting the wind turbine is performed in the case that the pivot angle of at least one wind turbine blade exceeds a variable pivot angle threshold being dependent on the azimuth position.

10. The method of claim 1, wherein the starting the wind turbine comprises:
connecting a generator to a rotating shaft of the wind turbine;
ramping up the generator, while controlling the biasing force applied by the biasing mechanism to the wind turbine blades; and
connecting the wind turbine to a power grid.

11. The method of claim 10, further comprising adjusting the biasing force in order to obtain a rotational acceleration of the generator which is substantially zero prior to connecting the generator to the rotating shaft of the wind turbine.

12. The method of claim 10, wherein the ramping up the generator comprises controlling the biasing force as a function of rotational speed of the hub and/or the generator, power output of the generator and pivot angle.

13. The method of claim 1, further comprising aligning the nacelle of the wind turbine in accordance with the direction of the wind, by means of the yaw system, prior to the step of adjusting the biasing mechanism.

14. A wind turbine, comprising:
a tower;
a nacelle disposed on the tower via a yaw system;
a generator disposed in the nacelle;
a rotor coupled to the generator;
a hub mounted on the rotor and comprising a blade carrying structure;
a plurality of wind turbine blades connected to the blade carrying structure via a hinge, each wind turbine blade thereby being arranged to perform pivot movements relative to the blade carrying structure between a minimum pivot angle and a maximum pivot angle;
an adjustable biasing mechanism arranged to apply an adjustable biasing force to each wind turbine blade which biases the wind turbine blade towards a position defining a minimum pivot angle;
one or more controllers configured to perform an operation starting a production of electrical energy of the wind turbine after a period of not producing electrical energy, the operation, comprising:
adjusting the biasing mechanism to apply a predefined biasing force to each wind turbine blade;
monitoring the pivot angle of each wind turbine blade; and
starting the wind turbine when the pivot angle of at least one wind turbine blade exceeds a predefined pivot angle threshold.

15. The wind turbine of claim 14, wherein the operation further comprises:
monitoring the rotational speed of the hub; and
starting the wind turbine in the case that the rotational speed of the hub exceeds a predefined rotational speed threshold.

16. The wind turbine of claim 14, wherein the starting the wind turbine comprises initially operating the generator of the wind turbine in motor mode.

17. The wind turbine of claim 14, wherein the predefined biasing force is selected to provide a predefined pivot angle at a predefined thrust force.

18. The wind turbine of claim 14, wherein the operation further comprises allowing a predefined time period to lapse between the adjusting the biasing mechanism and the monitoring the pivot angle.
